(19) United States
(12) Patent Application Publication
(10) Pub. No.: US 2011/0012452 A1
(43) Pub. Date: Jan. 20, 2011

(54) Drive and Drive System

(75) Inventor: Stefan Frits Brouwer, Schoonhoven (NL)

Correspondence Address: SWANSON & BRATSCHUN, L.L.C., 8210 SOUTHPARK TERRACE, LITTLETON, CO, 80120, US

(73) Assignee: MCi (Mirror Controls International) Netherlands B.V., Montfoort (NL)

(21) Appl. No.: 12/811,675

(22) PCT Filed: Jan. 15, 2009
(86) PCT No.: PCT/NL2009/050008

§ 371 Date: Aug. 27, 2010

(30) Foreign Application Priority Data
Jan. 15, 2008 (NL) 2001188

(51) Int. Cl. H02K 7/116

(52) U.S. Cl. 310/83

(57) ABSTRACT

Drive comprising a housing with a drive unit. The drive unit comprises an electric motor and a drive train comprising a reduction stage with an output shaft. The drive comprises an evoloid gear stage and a cover module which comprises a drive stage to be coupled with the output shaft of the drive train. The evoloid gear stage is preferably designed as a pinion with a toothing which comprises less than six, preferably two or three, teeth.

The invention relates to a drive comprising a housing with a drive unit provided with an electric motor and a drive train which comprises a reduction stage with an output shaft.

Such a drive is frequently used for opening and closing a car side window or a car rear window, or for operating window covering, such as for instance a sunshade.

A drawback of such a drive is that for each application an adapted housing needs to be made. Moreover, such a drive usually has a complex transmission.

The invention contemplates a drive of the type mentioned in the opening paragraph that obviates at least one of the disadvantages mentioned.

To this end, the invention provides a drive comprising a housing with a drive unit comprising an electric motor and a drive train which comprises a reduction stage with an output shaft, characterized in that the drive train comprises an evoloid gear stage and a cover module which comprises a drive stage coupled with the output shaft of the drive train.

By providing the housing with a cover module having a drive stage coupled to the output shaft, it is possible in a simple manner to adapt the drive to the application. Depending on the application, only a different cover module with drive stage coupled to the output shaft is needed. The cover module with drive stage can thus be especially adapted to the intended application, without this requiring a completely new housing. Thus the housing having the drive unit therein can remain substantially unaltered and the drive can be easily adapted to the application by making use of a different cover module.

By use of an evoloid gear stage, a high transmission can be realized in a single transmission stage.

By the use of the cover module with a drive stage coupled to the output shaft and an evoloid gear stage in the drive, the drive can be made of simple and inexpensive design. Also, a high efficiency can be achieved, so that the drive can easily be deployed for various applications.

An evoloid toothing in a pinion as a driving gear of the evoloid gear stage in this context is understood to be a pinion with a toothing according to DIN 3960, wherein
the number of teeth is less than 6, preferably 2 or 3;
the tooth angle is greater than 15°;
the profile correction of the pinion is greater than 0.5;
the profile correction of the main gear is less than or equal to 0;
the tooth root height factor of the main gear is greater than or equal to the tooth head height factor of the pinion; and
the tooth head height factor of the main gear is substantially equal to the tooth root height factor of the pinion.
   Such an evoloid toothing is discussed in more detail by K. Roth in Zahnrad Technik—Evolventen Sonderverzahnungen, Springer Verlag ISBN 3-540-64236-6.

By providing a cover module as an auxiliary cover for the housing, in case of a different application it is merely required to place an adapted auxiliary cover on the housing. Thus, the housing can be supplied as a whole, possibly with its own cover, after which a different auxiliary cover can be placed on it, depending on the application.

By providing the cover module with attaching eyes which are aligned with attaching eyes of the housing, the parts can simply, rapidly and easily be connected with each other. Also, at the same time the parts are properly positioned with respect to each other. Advantageously, use can thus be made of the attaching eyes of the housing for easy expansion of the housing.

By arranging the housing of the drive for receiving electric motors of different size, for instance by providing a stop in the housing, the housing can be easily and inexpensively used in different applications.

The invention also relates to a drive system.

Further advantageous embodiments of the invention are represented in the subclaims.

The invention will be elucidated on the basis of exemplary embodiments which are represented in a drawing. In the drawing:

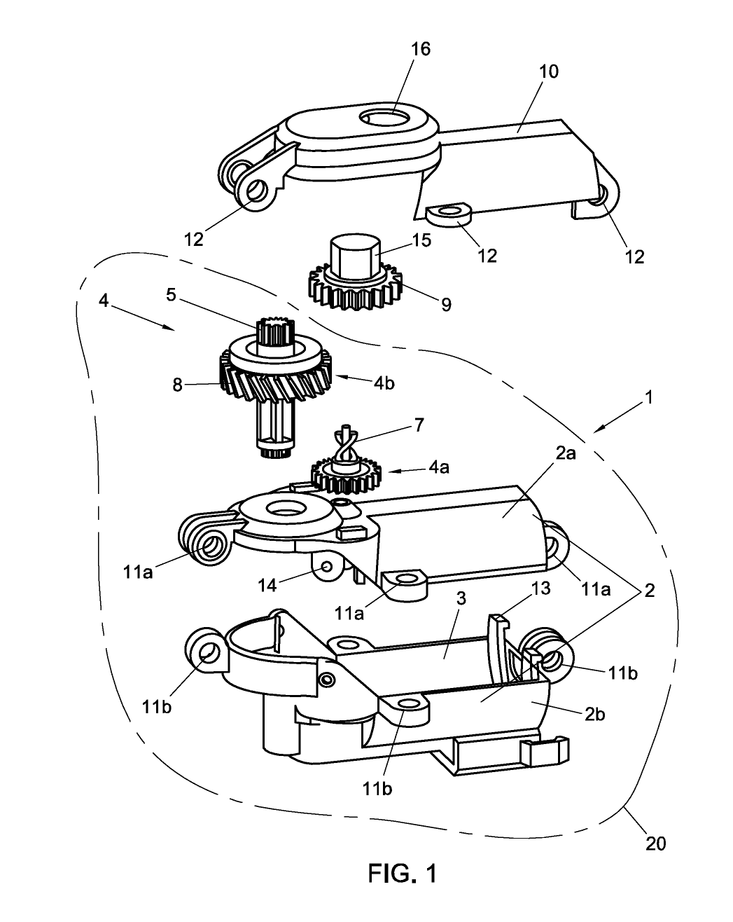

FIG. 1 shows a schematic perspective view of a first embodiment of a drive according to the invention in disassembled condition.

FIG. 2 shows a schematic perspective disassembled bottom view of a second embodiment of a drive according to the invention in disassembled condition.

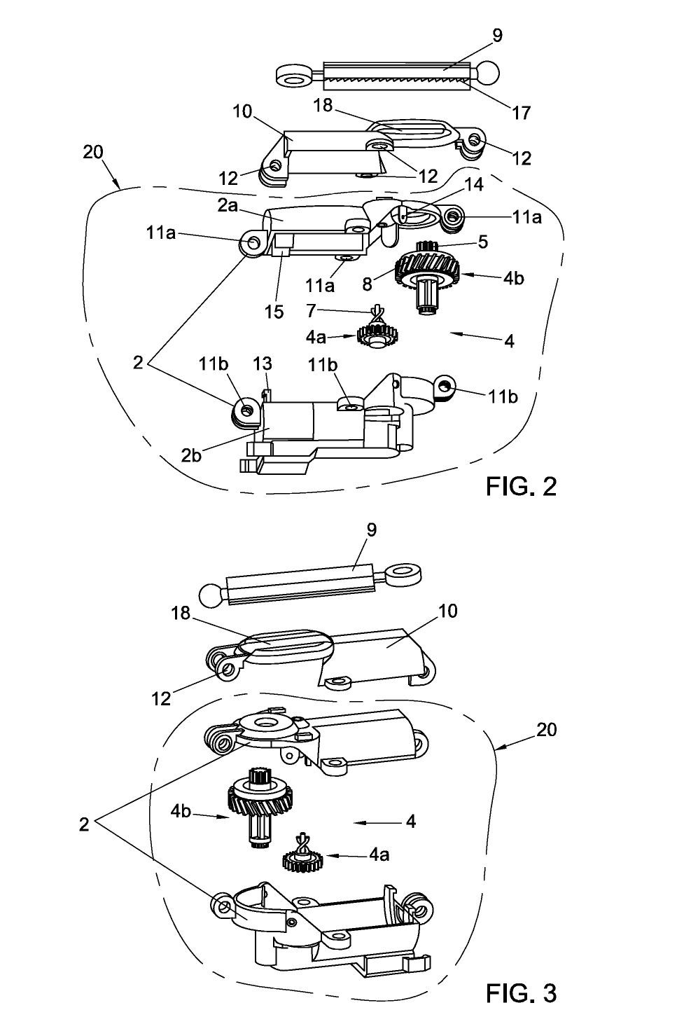

FIG. 3 shows a schematic perspective disassembled top plan view of the embodiment of FIG. 2.

It is noted that the drawing figures are only schematic representations of a preferred embodiment of the invention which is described by way of non-limitative exemplary embodiment. In the drawing figures, the same or corresponding parts are indicated by the same reference numerals.

FIG. 1 shows a drive 1 which comprises a housing 2. The housing 2 in this exemplary embodiment comprises two housing parts 2a and 2b, of which the housing part 2a serves as cover for housing part 2b. In the housing part 2b, in the space 3, an electric motor—not shown—can be accommodated.

The housing 2 is provided with a cover module 10 which in this exemplary embodiment is designed as an auxiliary cover 10.

However, the housing 2 can also be designed as the housing part 2b, without the cover 2a, with the cover module 10 then functioning as cover for the housing part 2b.

The drive 1 comprises a drive train 4, with the stages 4a and 4b shown in this exemplary embodiment. The stage 4a cooperates with a worm mounted on the output shaft of the electric motor—not shown here—and comprises a pinion 7. The pinion 7 has an evoloid toothing which cooperates with an evoloid main gear on the stage 4b. By the use of an evoloid toothing, in one transmission stage a high transmission ratio can be realized. Preferably, the evoloid pinion 7 has only two or three teeth. In FIG. 1 it can be seen that the evoloid pinion 7 in this example has two teeth.

The drive train 4, in this example comprising the stages 4a and 4b, is situated between the housing parts 2b and 2a. The housing parts 2a, 2b together with the electric motor and the drive train 4 form a basic unit 20.

The output shaft 5 of the drive train 4 in this exemplary embodiment cooperates with a drive stage 9 of the cover module 10. The drive stage 9 of the cover module 10 in FIG. 1 comprises a single transmission. In FIG. 2 the drive stage 9 of the cover module 10 is designed as a linear transmission. However, the drive stage 9 may also be designed as a reduction stage or an acceleration stage. Thus, on the housing 2 a cover module 10 can be placed which can be coupled to the output shaft 5 of the drive train 4, and which can be selected from a group of cover modules 10 having mutually different drive stages 9. The drive stage 9 cooperates with the cover module 10, and may for instance be carried by the cover module 10. In FIG. 1 it can be seen that a projection 15 of the drive stage 9 cooperates with a hole 16 in the auxiliary cover 10. In FIGS. 2 and 3 a toothing 17 of the drive stage 9 cooperates via a guide 18 in the auxiliary cover 10 with the output shaft 5 of the drive train 4.

The two parts of the housing 2, being the housing parts 2a and 2b, are provided with a number of mutually aligned attaching eyes 11a and 11b. Through the mutually aligned attaching eyes 11a and 11b, the housing parts 2a and 2b can be simply and rapidly coupled to each other, while at the same time a proper positioning of the two housing parts 2a and 2b with respect to each other can be achieved.

Optionally, the housing parts 2a and 2b may also be provided with a snap connection 13, 14, so that the housing parts 2a and 2b can remain firmly coupled with each other.

As can be seen in FIG. 1 and FIG. 2, the cover module 10 is also provided with attaching eyes 12, which are aligned with the attaching eyes 11a and 11b of the housing 2. By providing attaching eyes 11a, 11b, 12, an extra part—in this case auxiliary cover 10—can be easily placed on the housing 2 while use can be made of the attachment means already present on the housing 2. Also, at the same time, the cover module 10 is properly positioned with respect to the housing 2. The housing 2 is readily expandable in this way.

As the housing 2 is designed as two housing parts 2a and 2b which can be solidly connected with each other through attaching eyes and snap connection, such a housing can be prefabricated in large numbers, so that a drive with such a housing can be made of inexpensive design. Depending on the desired application, a different cover module 10 can then be mounted on the housing 2. This makes the drive 1 modular and suitable for a variety of applications.

The housing 2 together with the drive train 4 and the electric motor forms a standard basic unit 20, on which, depending on the application, a different cover module 10 with adapted drive stage 9 can be placed.

The housing 2 may be designed for receiving electric motors of different size. For this purpose, in the housing part 2b for instance a stop may be provided or a chamber in which a smaller electric motor could fit. Also, the coupling parts 15 of the housing part 2a that cooperate with the electric motor may be placed such that they can cooperate with, for instance, a smaller electric motor.

In the housing 2, further, a potentiometer may be provided for the purpose of a memory function. This may for instance be favorable when operating window covering, such as sunshades or curtains.

Also, the drive train 4 can comprise a slip coupling.

It will be clear that the invention is not limited to the exemplary embodiments represented here. Thus, the housing can optionally consist of more than two parts. Also, the cover module with drive stage may consist of two or more parts. Also, the drive train can comprise an additional transmission stage. Such variants will be clear to those skilled in the art and are understood to fall within the scope of the invention as set forth in the following claims.

1. A drive comprising a housing with a drive unit comprising:
an electric motor; and
a drive train which comprises a reduction stage with an output shaft, an evoloid gear stage and a cover module which comprises a drive stage cooperating with the output shaft of the drive train.

2. The drive according to claim 1, wherein the evoloid gear stage comprises a pinion with a toothing of less than six teeth.

3. The drive according to claim 1, wherein the drive stage of the cover module comprises a single transmission.

4. The drive according to claim 1, wherein the drive stage is one of an acceleration stage, a reduction stage and a linear stage.

5. The drive according to claim 1, wherein the cover module forms an auxiliary cover for the housing.

6. The drive according to claim 1, wherein the housing comprises at least two parts which are each provided with a number of attaching eyes.

7. The drive according to claim 6, wherein the cover module is provided with attaching eyes which are aligned with the attaching eyes of the housing.

8. The drive according to claim 6, wherein the at least two housing parts and/or the cover module mutually cooperate via a snap connection.

9. The drive according to claim 1, wherein the drive further comprises a potentiometer in the housing for the purpose of a memory function.

10. The drive according to claim 1, wherein the drive train further comprises a slip coupling.

11. The drive according to claim 1, wherein the housing is arranged for receiving electric motors of different size.

12. A drive system comprising a housing with a drive unit comprising an electric motor and a drive train which comprises a reduction stage with an output shaft, wherein the drive train comprises an evoloid gear stage and wherein on the housing a cover module can be placed which comprises a drive stage to be coupled with the output shaft of the drive train, and wherein the cover module can be selected from a group of cover modules having mutually different drive stages.

13. The drive according to claim 1, wherein the evoloid gear stage comprises a pinion with a toothing of three teeth.

14. The drive according to claim 1, wherein the evoloid gear stage comprises a pinion with a toothing of two teeth.
